(19) United States
(12) Patent Application Publication
(10) Pub. No.: US 2009/0198503 A1
(43) Pub. Date: Aug. 6, 2009

(54) ACKNOWLEDGING RECEIPT OF DELIVERED ARTICLE BY INTENDED RECEIVER

(75) Inventors: Christopher M. Marcoux-Norton, Colchester, VT (US); Eric J. Morin, Milton, VT (US)

Correspondence Address: HOFFMAN WARNICK LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 12/025,103

(22) Filed: Feb. 4, 2008

(51) Int. Cl. G06Q 99/00

(52) U.S. Cl. 705/1

(57) ABSTRACT

A method, system and computer program product for acknowledging receipt of an article by an intended receiver are disclosed. A method may comprise: communicating a receiver identification to the intended receiver; providing a mechanism to request an actual receiver of the article to provide the receiver identification; in response to that the actual receiver provides the receiver identification, generating a digital signature based on a combination of the receiver identification and an identification of the article; and acknowledging the receipt of the article by the intended receiver based on the digital signature.

### FIELD OF THE DISCLOSURE

The present disclosure relates in general to delivery confirmation, and more particularly to acknowledging receipt of a delivered article by an intended receiver through a digital signature.

### BACKGROUND OF THE DISCLOSURE

In a large corporate environment, delivered articles, for example computer, are typically distributed to end users through shipping services or hand delivery by specialized computer deployment teams. In the case where computers are delivered by a deployment team, the deployment personnel must obtain signature of the individual receiving the new computer as a proof of the delivery. Frequently, the delivered computers are received by an individual that is not the intended receiver, i.e., end user. For example, a manager may receive and sign a delivered computer for a new employee who has not yet arrived. If the delivery of the computer is later disputed, it is often difficult to discern who signed for the delivery due to poor handwriting or lost/damaged paperwork. It may also be difficult to prove receipt of a computer if the machine information regarding the computer was incorrectly recorded on the paperwork. Without the ability to prove receipt of a specific computer by a specific individual, a deployment service provider may be held accountable for the asset. In addition, the confirmation of computer delivery/receipt is also important for maintenance, software upgrading, and information security purposes. Accordingly, there exists a need in the art to overcome the deficiencies and limitations of the existing solutions, for example, those described hereinabove.

### SUMMARY OF THE DISCLOSURE

A first aspect of the disclosure is directed to a method for acknowledging receipt of an article by an intended receiver, the method comprising: communicating a receiver identification to the intended receiver; providing a mechanism to request an actual receiver of the article to provide the receiver identification; in response to that the actual receiver provides the receiver identification, generating a digital signature based on a combination of the receiver identification and an identification of the article; and acknowledging the receipt of the article by the intended receiver based on the digital signature.

A second aspect of the disclosure is directed to a system for acknowledging receipt of an article by an intended receiver, the system comprising: means for communicating a receiver identification to the intended receiver; means for requesting an actual receiver of the article to provide the receiver identification; means, responsive to that the actual receiver provides the receiver identification, for generating a digital signature based on a combination of the receiver identification and an identification of the article; and means for acknowledging the receipt of the article by the intended receiver based on the digital signature.

A third aspect of the disclosure is directed to a computer program product embodied in a computer readable medium comprising: computer usable program code which, when executed by a computer system, enables the computer system to: communicate a receiver identification to an intended receiver of an article; prompt a request for the receiver identification to an actual receiver of the article; responsive to that the actual receiver inputs the receiver identification, generate a digital signature based on a combination of the receiver identification and an identification of the article; and acknowledge the receipt of the article by the intended receiver based on the digital signature.

A fourth aspect of the disclosure is directed to a method for providing a system for acknowledging receipt of an article by an intended receiver, comprising: at least one of: creating, maintaining, deploying or supporting a computer infrastructure being operable to: communicate a receiver identification to an intended receiver of an article; prompt a request for the receiver identification to an actual receiver of the article; responsive to that the actual receiver inputs the receiver identification, generate a digital signature based on a combination of the receiver identification and an identification of the article; and acknowledge the receipt of the article by the intended receiver based on the digital signature.

Other aspects and features of the present disclosure, as defined solely by the claims, will become apparent to those ordinarily skilled in the art upon review of the following non-limited detailed description of the disclosure in conjunction with the accompanying figures.

### BRIEF DESCRIPTION OF THE DRAWINGS

The embodiments of this disclosure will be described in detail, with reference to the following figures, wherein like designations denote like elements, and wherein:

FIG. 1 shows a block diagram of a system according to an embodiment of the disclosure.

FIG. 2 shows an embodiment of the operation of a receipt confirmation system.

It is noted that the drawings of the disclosure are not to scale. The drawings are intended to depict only typical aspects of the disclosure, and therefore should not be considered as limiting the scope of the disclosure. In the drawings, like numbering represents like elements among the drawings.

### DETAILED DESCRIPTION OF THE DISCLOSURE

The following detailed description of embodiments refers to the accompanying drawings, which illustrate specific embodiments of the disclosure. Other embodiments having different structures and operations do not depart from the scope of the present disclosure.

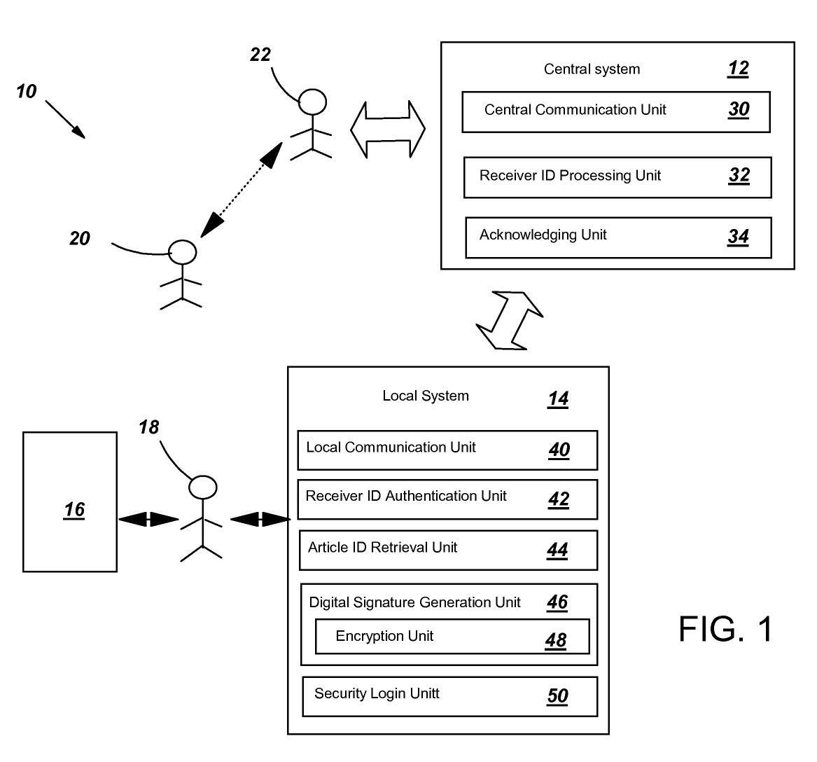

FIG. 1 shows a block diagram of a system 10 according to an embodiment. System 10 includes a central system 12, e.g., a central server, and a local system 14. Local system 14 may be accompanied along with an article 16 under the control of delivery controller 18, e.g., delivery personnel. Delivery controller 18 may make article 16 available to actual receiver 20. Actual receiver 20 may be an intended receiver 22 or may be a different individual. It should be appreciated that delivery controller 18 may be an individual physically delivering article 16 to actual receiver 20 or may be any mechanism remotely controlling the delivery of a physical article 16 or a non-physical article 16, e.g., computer software program codes, to actual receiver 20. In the description herein, the term “delivery” refers to a transference of the control of article 16 to actual receiver 20, which essentially means that actual receiver 20 receives article 16.

Central system 12 may include a central communication unit 30, a receiver identification (ID) processing unit 32, and an acknowledging unit 34. Local system 14 may include a local communication unit 40, a receiver identification (ID) authentication unit 42, an article identification (ID) retrieval unit 44, a digital signature generation unit 46 including an encryption unit 48, and a security login unit 50. It should be appreciated that components of central system 12 and local system 14 may interchange, and in certain embodiments, the division of central system 12 and local system 14 is not necessary. For example, functions of central system 12 and local system 14 may be performed by a single processing system in the situation of, e.g., the remote control of software downloading. In the following description, a physical delivery of an article 16, e.g., a computer, will be used as an illustrative example to describe the operation of system 10, which does not limit the scope of the disclosure. The disclosure may similarly be applied to other manners of article delivery, e.g., an on-line downloading of software codes.

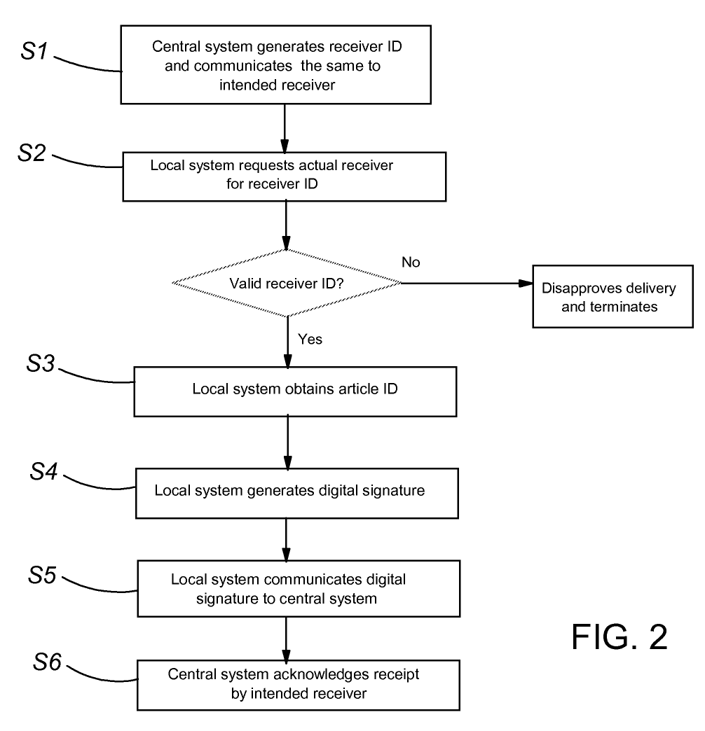

FIG. 2 shows embodiment of an operation of system 10. Referring to FIGS. 1-2, collectively, in process S1, receiver identification processing unit 32 of central system 12 generates a receiver identification and coordinates with central communication unit 30 to communicate the generated receiver identification to intended receiver 22 of a to-be-delivered computer 16. The receiver identification may be communicated in any manner and all are included. For example, an email message may be sent to intended receiver 22 which contains the receiver identification. According to an embodiment, the communication of the receiver identification may be implemented in a secured manner, e.g., using encryption.

In process S2, when computer 16 is made available for delivery to actual receiver 20, receiver identification authentication unit 42 of local system 14, which accompanies with computer 16 and/or delivery controller 18, may prompt a request for receiver identification through, e.g., a GUI window. In an embodiment, local system 14 may include software program code downloaded from a base, e.g., central system 12, and saved in and operated through computer 16 (article) to be delivered. Other embodiments are also possible. For example, local system 14 may reside in a portable terminal with delivery controller 18. If actual receiver 20 provides a valid/authentic receiver identification, i.e., the provided receiver identification matches the receiver identification communicated to intended receiver 22, receiver identification authentication unit 42 may approve a delivery of computer 16 to actual receiver 20 and the operation of system proceeds to process S3. In this situation, actual receiver 20 may be intended receiver 22 himself or may be authorized by intended receiver 22 to receive computer 16, e.g., intended receiver 22 giving the received receiver identification to actual receiver 20. If actual receiver 20 fails to provide valid receiver identification, e.g., no receiver identification or non-matching receiver identification, receiver identification authentication unit 42 may disapprove a delivery of computer 16 to actual receiver 20, and the operation of system 10 terminates. The authenticating of receiver identification provided by actual receiver 20 may be implemented directly by receiver identification authentication unit 42 or may be processed by receiver identification processing unit 32. In the latter situation, receiver identification authentication unit 42 may communicate the provided receiver identification to receiver identification processing unit 32 for authentication.

In process S3, article identification (ID) retrieval unit 44 obtains an article identification of article 16, here computer 16. The article identification may be any information that identifies computer 16. Any now known or later developed method may be used in obtaining the article identification of computer 16. For example, article identification retrieval unit 44 may scan a serial number of a component or a combination of serial numbers of multiple components of computer 16 as the article identification. Article identification retrieval unit 44 may also retrieve a saved article identification code. Preferably, article identification retrieval unit 44 retrieves the article identification from article 16, here computer 16, actually delivered.

In process S4, digital signature generation unit 46 generates a digital signature based on a combination of the receiver identification and the article identification. The digital signature may be in any format and all are included. According to an embodiment, the digital signature includes both an encrypted portion and a non-encrypted portion, i.e., a plain text portion. The encrypted portion may include the receiver identification and the article identification, and the plain text portion may include other identification information of intended receiver 22 and/or article 16. The plain text portion may facilitate the storage and the retrieval of the digital signature, as will be described herein. Encryption unit 48 may implement the encryption.

According to an embodiment, digital signature generation unit 46 creates/builds a URL that contains variables including the encrypted portion, e.g., the combination of receiver identification and article identification, and the plain text portion. The URL enables a web server to extract the information contained in the plain text portion to display on a web page.

In process S5, local communication unit 40 communicates the generated digital signature to central system 12, specifically, acknowledging unit 34, for acknowledging the receipt of computer 16 by intended receiver 22 based on the digital signature. According to an embodiment, local communication unit 40 may require a security login for communicating the digital signature. Specifically, security login unit 50 may prompt a login request for an authorized individual, e.g., delivery controller 18, to log in. The digital signature can only be communicated upon a successful login to access the communication function.

According to an embodiment, following up the URL embodiment above, the URL may be built to direct to a server that requires security login to access. When the URL is opened via local system 14, security login unit 50 may prompt a login request for delivery controller 18. Upon a successful login, delivery controller 18 may access the web page directed by the URL which contains the digital signature. The web page may also contain a “submit” button for delivery controller 18 to submit/communicate the digital signature to central system 12. The web page may also include a frame field for delivery controller 18 to make notes on the delivery.

In S6, acknowledging unit 34 acknowledges the receipt of article 16 by intended receiver 22 based on the digital signature. Any use of the digital signature for receipt acknowledging purposes is possible. For example, the digital signature may be saved with other information regarding the article 16 delivery, e.g., delivery controller 18 identification and the notes made by delivery controller 18 regarding the delivery, in a database. An acknowledgement/verification of the receipt may be performed by searching the data base to retrieve the digital signature and the related information.

While shown and described herein as a method and system for acknowledging receipt of an article by an intended receiver, it is understood that the disclosure further provides various alternative embodiments. For example, in an embodiment, the disclosure provides a program product stored on a computer-readable medium, which when executed, enables a computer infrastructure to acknowledge receipt of an article by an intended receiver. To this extent, the computer-readable medium includes program code, such as components of local system 14 and/or central system 12, which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, and/or as a data signal traveling over a network (e.g., during a wired/wireless electronic distribution of the program product).

It should be appreciated that the teachings of the present disclosure could be offered as a business method on a subscription or fee basis. For example, a local system 14 and a central system 12 could be created, maintained, deployed and/or supported by a service provider that offers the functions described herein for customers. That is, a service provider could offer to acknowledge receipt of an article by an intended receiver as described above.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the disclosure has other applications in other environments. This application is intended to cover any adaptations or variations of the present disclosure. The following claims are in no way intended to limit the scope of the disclosure to the specific embodiments described herein.

What is claimed is:

1. A method for acknowledging receipt of an article by an intended receiver, the method comprising:
communicating a receiver identification to the intended receiver;
providing a mechanism to request an actual receiver of the article to provide the receiver identification;
in response to that the actual receiver provides the receiver identification, generating a digital signature based on a combination of the receiver identification and an identification of the article; and
acknowledging the receipt of the article by the intended receiver based on the digital signature.

2. The method of claim 1, wherein the digital signature includes an encrypted portion containing the receiver identification and the article identification.

3. The method of claim 2, wherein the digital signature includes a plain text portion containing at least one of: another identification of the intended receiver or another identification of the article.

4. The method of claim 1, wherein the generating includes creating a URL that contains a variable of the combination of the receiver identification and the article identification.

5. The method of claim 1, wherein the acknowledging includes providing a mechanism for communicating the digital signature to a centralized server to acknowledge the receipt.

6. The method of claim 5, wherein the communicating mechanism requires a security login of an authorized individual to communicate the digital signature.

7. A system for acknowledging receipt of an article by an intended receiver, the system comprising:
means for communicating a receiver identification to the intended receiver;
means for requesting an actual receiver of the article to provide the receiver identification;
means, responsive to that the actual receiver provides the receiver identification, for generating a digital signature based on a combination of the receiver identification and an identification of the article; and
means for acknowledging the receipt of the article by the intended receiver based on the digital signature.

8. The system of claim 7, wherein the digital signature includes an encrypted portion containing the receiver identification and the article identification.

9. The system of claim 8, wherein the digital signature includes a plain text portion containing at least one of: another identification of the intended receiver or another identification of the article.

10. The system of claim 7, wherein the generating means creates a URL that contains a variable of the combination of the receiver identification and the article identification.

11. The system of claim 7, wherein the acknowledging means includes a communication means for communicating the digital signature to a centralized server to acknowledge the receipt.

12. The system of claim 11, wherein the communicating means requires a security login of an authorized individual to communicate the digital signature.

13. A computer program product embodied in a computer readable medium comprising:
computer usable program code which, when executed by a computer system, enables the computer system to:
communicate a receiver identification to an intended receiver of an article;
prompt a request for the receiver identification to an actual receiver of the article;
responsive to that the actual receiver inputs the receiver identification, generate a digital signature based on a combination of the receiver identification and an identification of the article; and
acknowledge the receipt of the article by the intended receiver based on the digital signature.

14. The program product of claim 13, wherein the digital signature includes an encrypted portion containing the receiver identification and the article identification.

15. The program product of claim 14, wherein the digital signature includes a plain text portion containing at least one of: another identification of the intended receiver or another identification of the article.

16. The program product of claim 13, wherein the program code is configured to enable the computer system to create a URL that contains a variable of the combination of the receiver identification and the article identification.

17. The program product of claim 13, wherein the program code is configured to enable the computer system to communicate the digital signature to a centralized server to acknowledge the receipt.

18. The program product of claim 17, wherein the program code is configured to enable the computer system to prompt a security login request for an authorized individual to communicate the digital signature.

19. A method for providing a system for acknowledging receipt of an article by an intended receiver, comprising:
at least one of: creating, maintaining, deploying or supporting a computer infrastructure being operable to:
communicate a receiver identification to an intended receiver of an article;
prompt a request for the receiver identification to an actual receiver of the article;
responsive to that the actual receiver inputs the receiver identification, generate a digital signature based on a combination of the receiver identification and an identification of the article; and
acknowledge the receipt of the article by the intended receiver based on the digital signature.

20. The method of claim 19, wherein the digital signature includes an encrypted portion containing the receiver identification and the article identification.

21. The method of claim 20, wherein the digital signature includes a plain text portion containing at least one of: another identification of the intended receiver or another identification of the article.

22. The method of claim 19, wherein the computer infrastructure is operable to create a URL that contains a variable of the combination of the receiver identification and the article identification.

23. The method of claim 19, wherein the computer infrastructure is operable to communicate the digital signature to a centralized server to acknowledge the receipt.

24. The method of claim 23, wherein the computer infrastructure is operable to prompt a security login request for an authorized individual to communicate the digital signature.
